(19) United States
(12) Patent Application Publication
(10) Pub. No.: US 2024/0147904 A1
(43) Pub. Date: May 9, 2024

(54) SYSTEMS AND METHODS FOR SETTING A BOUNDARY FOR A REEL OF AN AGRICULTURAL HEADER

(71) Applicant: CNH Industrial America LLC, New Holland, PA (US)

(72) Inventors: Cory Douglas Hunt, Millersville, PA (US); Jethro Martin, Ephrata, PA (US)

(21) Appl. No.: 18/504,081

(22) Filed: Nov. 7, 2023

Related U.S. Application Data
(60) Provisional application No. 63/423,106, filed on Nov. 7, 2022.

(51) Int. Cl. A01D 57/04; A01D 34/04

(52) U.S. Cl. CPC A01D 57/04; A01D 34/04

(57) ABSTRACT

An agricultural system includes a frame, a cutter bar assembly, and a reel. The agricultural system also includes a controller configured to receive data indicative a position of the cutter bar assembly relative to the frame over a first time period of a harvesting operation, receive an input of a risk level for contact between the cutter bar assembly and the reel during the harvesting operation, generate a boundary for the reel based on the position of the cutter bar assembly relative to the frame over the first time period of the harvesting operation and the input, and control the reel based on the boundary during a second time period of the harvesting operation.

### BACKGROUND

The present disclosure relates generally to systems and methods for setting a boundary for a reel of an agricultural header.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A harvester may be used to harvest crops, such as barley, beans, beets, carrots, corn, cotton, flax, oats, potatoes, rye, soybeans, wheat, or other plants. A harvesting process may begin by operating a header of the harvester to remove a portion of a plant from a field. In some cases, the header may cut the plant to form cut crops and transport the cut crops to a processing system of the harvester.

Certain headers include a cutter bar assembly configured to cut a portion of each plant (e.g., a stalk), thereby separating the cut crops from the soil. The cutter bar assembly may extend along a substantial portion of a width of the header at a forward end of the header. The header may also include one or more belts positioned behind the cutter bar assembly relative to a direction of travel of the harvester. The belt(s) are configured to transport the cut crops to an inlet of the processing system.

Certain headers may also include a reel, which may include a reel member having multiple fingers extending from a central framework. The central framework is driven to rotate, such that the fingers move in a circular pattern. The fingers are configured to engage the plants, thereby preparing the plants to be cut by the cutter bar assembly and/or urging the cut crops to move toward the belt(s). The reel member is typically supported by multiple arms extending from a frame of the header. The reel may include one or more actuators configured to drive the multiple arms to rotate, thereby adjusting a position of the reel relative to the frame of the header.

### SUMMARY

Certain embodiments commensurate in scope with the originally claimed subject matter are summarized below. These embodiments are not intended to limit the scope of the claimed subject matter, but rather these embodiments are intended only to provide a brief summary of possible forms of the disclosure. Indeed, the disclosure may encompass a variety of forms that may be similar to or different from the embodiments set forth below.

In an embodiment, an agricultural system includes a frame, a cutter bar assembly configured to cut crops and to move relative to the frame during a harvesting operation of the agricultural system, and a reel configured to guide the crops toward the cutter bar assembly and to move relative to the frame during the harvesting operation of the agricultural system. The agricultural system also includes a controller configured to receive data indicative of a position of the cutter bar assembly relative to the frame over a first time period of the harvesting operation, receive an input of a risk level for contact between the cutter bar assembly and the reel during the harvesting operation, generate a boundary for the reel based on the position of the cutter bar assembly relative to the frame over the first time period of the harvesting operation and the input, and control the reel based on the boundary during a second time period of the harvesting operation.

In an embodiment, an agricultural system includes a controller configured to receive data indicative a position of a cutter bar assembly of a header of the agricultural system relative to a frame of the header over a first time period of a harvesting operation and receive an input of a risk level for contact between the cutter bar assembly and a reel of the header during the harvesting operation. The controller is also configured to generate a boundary for the reel based on the position of the cutter bar assembly relative to the frame over the first time period of the harvesting operation and the input and control the reel based on the boundary during a second time period of the harvesting operation.

In an embodiment, a method of operating an agricultural system includes receiving, at one or more processors, data indicative a position of a cutter bar assembly relative to a frame over a first time period of a harvesting operation. The method also includes receiving, at the one or more processors, an input of a risk level for contact between the cutter bar assembly and a reel during the harvesting operation. The method also includes generating, using the one or more processors, a boundary for the reel based on the position of the cutter bar assembly relative to the frame over the first time period of the harvesting operation and the input. The method further includes controlling, using the one or more processors, the reel based on the boundary during a second time period of the harvesting operation.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an agricultural system, in accordance with an embodiment of the present disclosure;

FIG. 2 is a perspective view of a header that may be employed within the agricultural system of FIG. 1, in accordance with an embodiment of the present disclosure;

FIG. 3 is a cross-sectional side view of the header of FIG. 2, in accordance with an embodiment of the present disclosure;

FIG. 4 is an example of a graph that represents a distribution of a position of a cutter bar assembly over a time period, wherein the cutter bar assembly may be employed within the header of FIG. 2, in accordance with an embodiment of the present disclosure;

FIG. 5 is an example of a graph that represents a user-defined resultant position of the cutter bar assembly, in accordance with an embodiment of the present disclosure;

FIG. 6 is a schematic side view of a portion of the header of FIG. 2 that represents a relationship between the user-defined resultant position of the cutter bar assembly and a reel, in accordance with an embodiment of the present disclosure;

FIG. 7 is an example of a graph of a boundary for the reel and associated actions for the reel based on a position of the reel relative to the boundary for the reel assembly, in accordance with an embodiment of the present disclosure;

FIG. 8 is a schematic diagram of a control system that may be utilized to generate and to apply the boundary for the reel, in accordance with an embodiment of the present disclosure;

FIG. 9 is a graphical user interface that may be provided via a display screen, in accordance with an embodiment of the present disclosure; and

FIG. 10 is a flowchart of a method for generating a boundary for a reel of a header, in accordance with an aspect of the present disclosure.

### DETAILED DESCRIPTION

One or more of the specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The process of farming typically begins with planting seeds within a field. Over time, the seeds grow and eventually become harvestable crops. Often, only a portion of each crop is commercially valuable, so each crop is harvested to separate the usable material from the remainder of the crop. For example, a harvester may cut crops within a field via a header, which may include a flexible draper header. The header may include a cutter bar assembly configured to cut the crops. As the cutter bar assembly cuts the crops, a conveyor coupled to draper deck(s) of the header moves the cut crops toward a crop processing system of the harvester. For example, the conveyor on the side draper deck(s) may move the cut crops toward an infeed draper deck at a center of the header. A conveyor on the infeed draper deck may then move the cut crops toward the crop processing system. The crop processing system may include a threshing machine configured to thresh the cut crops, thereby separating the cut crops into certain desired agricultural materials, such as grain, and material other than grain (MOG). The desired agricultural materials may be sifted and then accumulated into a tank. When the tank fills to capacity, the desired agricultural materials may be collected from the tank. The MOG may be discarded from the harvester (e.g., via a spreader) by passing through an exit pipe or a spreader to fall down onto the field.

In some embodiments, portions of the cutter bar assembly may move so as to follow a contour of the field. For example, the cutter bar assembly may be flexible to remain in contact with the field during harvesting operations. Furthermore, the header of the harvester includes a reel (e.g., reel assembly) configured to prepare the crops to be cut by the cutter bar assembly. As an example, the reel may be positioned adjacent to the cutter bar assembly and may be configured to guide the crops toward the cutter bar assembly to facilitate cutting the crops. The position of the reel is adjustable relative to the cutter bar assembly so as to enable the reel to effectively guide the crops toward the cutter bar assembly. However, in some circumstances, the cutter bar assembly and the reel may interfere with one another. For instance, the cutter bar assembly may contact part of the reel (e.g., a tine of the reel), thereby limiting an effectiveness of the cutter bar assembly, the reel, and the header.

It is now recognized that limiting a position (e.g., lower position) of the reel to avoid contact with the cutter bar assembly may improve operation of the header. Therefore, the present disclosure is directed to generating one or more boundaries (e.g., lower boundaries) for the reel, and then providing one or more outputs based on the one or more boundaries. The one or more outputs may include an action control signal to maintain and/or adjust (e.g., move) the reel at or above a boundary (e.g., a set boundary of the one or more boundaries), a slow control signal to adjust (e.g., slow) movement of the reel below the boundary, a block control signal to block movement of the reel below the boundary, and/or an alert (e.g., visible and/or audible alert) to an operator in response to an operator input that instructs movement of the reel below the boundary. Advantageously, the boundary may be established for each header (e.g., specific to each header) based on a geometry of the header. Further, the boundary may be established for each header based on conditions of a field (e.g., that is currently being harvested by the header). In particular, the boundary may be established based on statistical movements of the cutter bar assembly over time, such as during an initial portion of a harvesting operation, as well as based on modeling of respective tine paths of tines of the reel at different positions of the reel. In some embodiments, sensor feedback (e.g., sensor data) collected during operation of the header may be used to adjust the boundary. Furthermore, the boundary is associated with a risk level for contact between the reel and the cutter bar assembly. In some embodiments, the risk level is selected by an operator. Different operators may have different preferences related to the risk level for any of a variety of reasons, such as due to individual tolerance for making repairs to the reel, for example.

In any case, after the boundary is set (e.g., selected) for the header, the operator may then adjust the reel to move (e.g., fore/aft and/or up/down) relative to the cutter bar assembly. For example, the operator may provide inputs to adjust the reel to move relative to the cutter bar assembly as the header travels through a field during a harvesting operation. However, the controller may block the reel from being moved across (e.g., below; toward the cutting bar assembly) the boundary that is set for the header. Additionally or alternatively, the controller may slow movement of the reel below the boundary that is set for the header (e.g., move the reel at a first, faster rate above the boundary and move the reel at a second, slower rate below the boundary; move the reel quickly to a set point above the boundary, move the reel slowly via small incremental steps toward the set point below the boundary until detection of a threshold distance), provide the alert to the operator in response to the operator input that instructs movement of the reel below the boundary that is set for the header, and/or provide other outputs based on the boundary that is set for the header. In some embodiments, the controller may maintain and/or adjust (e.g., move) the reel at or above the boundary

It should be appreciated that the controller may instruct display of selectable icons (e.g., virtual buttons) that enable the operator to input preferences with respect to the outputs, such as preferences related to providing upward movement of the reel, blocking downward movement of the reel, adjusting/slowing downward movement of the reel, and/or providing alerts. For example, the operator may prefer that the controller block the downward movement of the reel during some periods of time/passes through the field and slow the downward movement of the reel during other periods of times/passes through the field. However, in some embodiments, the controller may control these features, such as by blocking the downward movement of the reel during certain periods of time/passes through the field, but merely slowing the downward movement of the reel during certain periods of time/passes through the field.

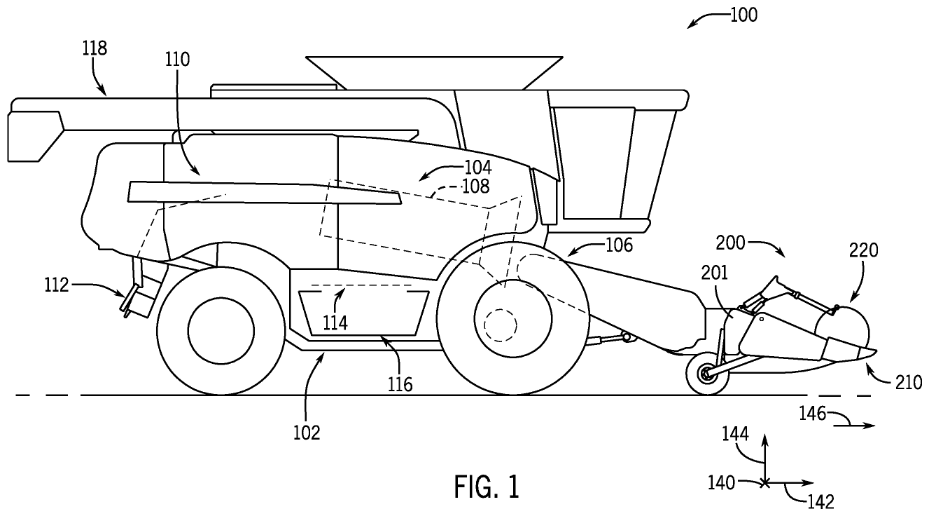

With the foregoing in mind, FIG. 1 is a side view of an embodiment of an agricultural system 100, which may be a harvester. The agricultural system 100 includes a chassis 102 configured to support a header 200 and an agricultural crop processing system 104. The header 200 is configured to cut crops and to transport the cut crops toward an inlet 106 of the agricultural crop processing system 104 for further processing of the cut crops.

The agricultural crop processing system 104 receives the cut crops from the header 200 and separates desired crop material from crop residue. For example, the agricultural crop processing system 104 may include a thresher 108 having a cylindrical threshing rotor that transports the cut crops in a helical flow path through the agricultural system 100. The thresher 108 may also separate the desired crop material (e.g., grain) from the crop residue (e.g., husks and pods), and the thresher 108 may enable the desired crop material to flow into a cleaning system 114 located beneath the thresher 108.

The cleaning system 114 may remove debris from the desired crop material and transport the desired crop material to a storage tank 116 within the agricultural system 100. When the storage tank 116 is full, a tractor with a trailer on the back may pull alongside the agricultural system 100. The desired crop material collected in the storage tank 116 may be carried up by an elevator and dumped out of an unloader 118 into the trailer. The crop residue may be transported from the thresher 108 to a crop residue handling system 110, which may process (e.g., chop/shred) and remove the crop residue from the agricultural system 100 via a crop residue spreading system 112 positioned at an aft end of the agricultural system 100. To facilitate discussion, the agricultural system 100 and/or its components may be described with reference to a lateral axis or direction 140, a longitudinal axis or direction 142, and a vertical axis or direction 144. The agricultural system 100 and/or its components may also be described with reference to a direction of travel 146 (e.g., forward direction of travel).

As discussed in detail below, the header 200 includes a cutter bar assembly 210 configured to cut the crops within the field. The header 200 also includes a reel 220 (e.g., reel assembly) configured to engage the crops to prepare the crops to be cut by the cutter bar assembly 210 and/or to urge the crops cut by the cutter bar assembly 210 onto a conveyor system that directs the cut crops toward the inlet 106 of the agricultural crop processing system 104. The reel 220 includes a reel member having multiple tines (e.g., fingers) extending from a central framework. The central framework is driven to rotate such that the tines engage the crops and urge the crops toward the cutter bar assembly 210 and the conveyor system. Additionally, the reel members may be slidingly supported on multiple arms (e.g., reel arms) that are coupled to a frame 201 of the header 200. Furthermore, each of the arms may be coupled to the frame 201 via a respective pivot joint. For example, one pivot joint is configured to enable a first arm of the multiple arms to pivot (e.g., about the lateral axis 140) relative to the frame 201, and another pivot joint is configured to enable a second arm of the multiple arms to pivot (e.g., about the lateral axis 140) relative to the frame 201. It should be appreciated the header with the cutter bar assembly and the reel may be employed in any suitable type of harvester or similar machine (e.g., swathers/windrowers that gather the cut crops to form a windrow in the field that is later collected by the harvester).

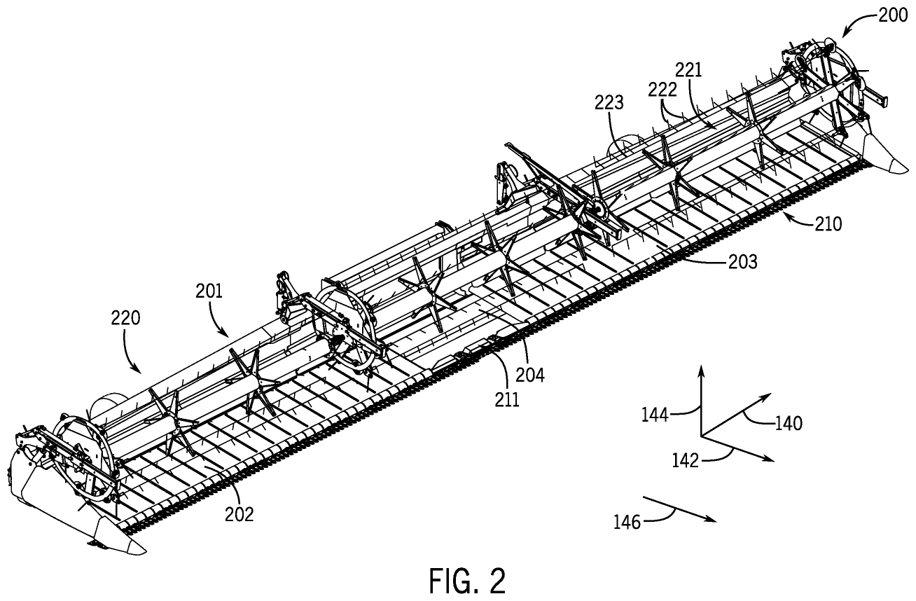

FIG. 2 is a perspective view of an embodiment of the header 200. In the illustrated embodiment, the header 200 includes the cutter bar assembly 210 configured to cut a portion of each crop (e.g., a stalk), thereby separating the crop from the soil. The cutter bar assembly 210 is positioned at a forward end of the header 200 relative to the longitudinal axis 142 of the header 200. As illustrated, the cutter bar assembly 210 extends along a substantial portion of the width of the header 200 (e.g., along the lateral axis 140).

The cutter bar assembly 210 includes a blade support, a stationary guard assembly, and a moving blade assembly. The moving blade assembly is fixed to the blade support (e.g., above the blade support along the vertical axis 144 of the header 200), and the blade support/moving blade assembly is driven to oscillate relative to the stationary guard assembly. The blade support/moving blade assembly may be driven to oscillate by a driving mechanism 211 positioned at a center of the header 200. However, in other embodiments, the blade support/moving blade assembly may be driven by another suitable mechanism (e.g., located at any suitable position on the header 200). As the agricultural system 100 is driven through the field, the cutter bar assembly 210 engages crops within the field, and the moving blade assembly cuts the crops (e.g., the stalks of the crops) in response to engagement of the cutter bar assembly 210 with the crops.

In the illustrated embodiment, the header 200 includes a first conveyor section 202 on a first lateral side of the header 200 and a second conveyor section 203 on a second lateral side of the header 200 opposite the first lateral side. The conveyor sections 202, 203 may be separate from one another. For instance, the first conveyor section 202 may extend along a portion of a width of the header 200 and the second conveyor section 203 may extend along another portion of the width of the header 200. Each conveyor section 202, 203 is driven to rotate by a suitable drive mechanism, such as an electric motor or a hydraulic motor. The first conveyor section 202 and the second conveyor section 203 are driven such that a top surface of each conveyor section 202, 203 moves laterally inward to a center conveyor section 204 positioned between the first conveyor section 202 and the second conveyor section 203 along the lateral axis 140. The center conveyor section 204 may also be driven to rotate by a suitable drive mechanism, such as an electric motor or a hydraulic motor. The center conveyor section 204 is driven such that the top surface of the center conveyor section 204 moves rearwardly relative to the direction of travel 146 toward the inlet. As a result, the conveyor sections 202, 203, 204 transport the cut crops through the inlet to the agricultural crop processing system for further processing of the cut crops. Although the illustrated header 200 includes two conveyor sections 202, 203 configured to direct crops toward the center conveyor section 204, there may be any suitable number of conveyor sections in additional or alternative embodiments directing the crops toward the center conveyor section.

The crops cut by the cutter bar assembly 210 are directed toward the conveyor sections 202, 203 at least in part by the reel 220, thereby substantially reducing the possibility of the cut crops falling onto the surface of the field. The reel 220 includes a reel member 221 (e.g., wheel) having multiple fingers or tines 222 extending from a central framework 223. The central framework 223 is driven to rotate such that the tines 222 move (e.g., in a circular pattern). The tines 222 are configured to engage the crops and urge the cut crops toward the conveyor sections 202, 203 to facilitate transport of the cut crops to the agricultural crop processing system.

In some embodiments, the frame 201 of the header 200 may be movably coupled to the chassis of the agricultural system. As illustrated herein, the cutter bar assembly 210 is flexible along the width of the header 200. In particular, the cutter bar assembly 210 is supported by multiple arm assemblies distributed along the width of the header 200. Each arm assembly is mounted to the frame 201 and includes an arm coupled to the cutter bar assembly 210. The arm may rotate and/or move the cutter bar assembly 210 along the vertical axis 144 relative to the frame 201, thereby enabling the cutter bar assembly 210 to flex during operation of the agricultural system. Thus, the cutter bar assembly 210 may follow the contours of the field, thereby enabling the cutting height (e.g., the height at which each crop is cut) to be substantially constant along the width of the header 200.

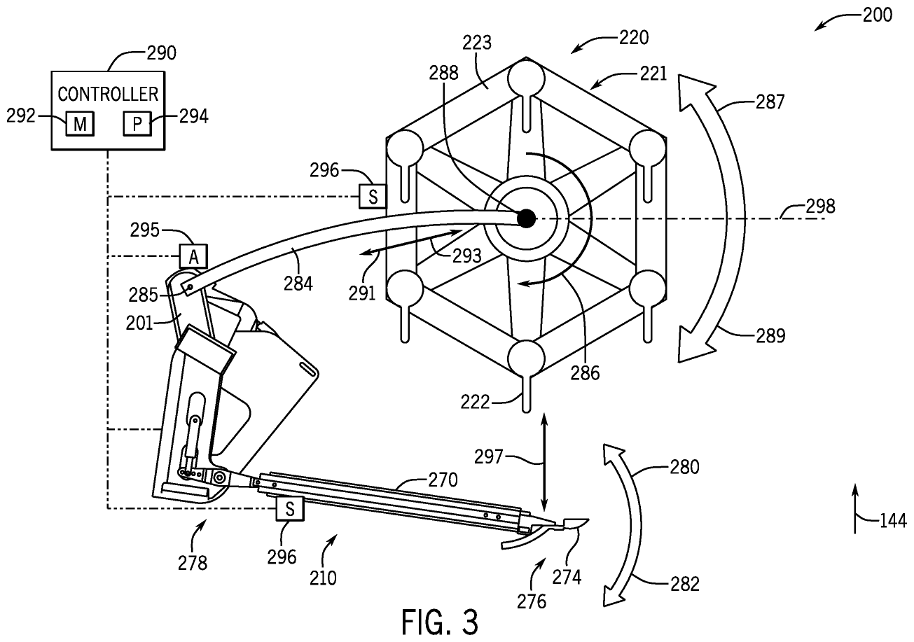

FIG. 3 is a cross-sectional side view of an embodiment of the header 200. As shown, the cutter bar assembly 210 includes arms 270 supporting blades 274 at a first end 276 of the arms 270. Further, the arms 270 may be coupled to the frame 201 of the header 200 at a second end 278 of the arms 270. As an example, the arms 270 may be pivotably coupled to the frame 201 at the second end 278. In this manner, the arms 270 may be configured to rotate relative to the frame 201. As such, the arms 270 may rotate in a first rotational direction 280 (e.g., upward), which may raise the arms 270 along the vertical axis 144, and the arms 270 may rotate in a second rotational direction 282 (e.g., downward), which may lower the arms 270 along the vertical axis 144.

In certain embodiments, the arms 270 may freely rotate in the rotational directions 280, 282 to follow a contour of the field. For example, the arms 270 may position the blades 274 to maintain contact with the field. As such, an upward slope of the field may push the arms 270 to rotate in the first rotational direction 280 to raise the blades 274 relative to the frame 201 and therefore avoid inserting the blades 274 into the field. Moreover, at a downward slope of the field, the weight of the blades 274 may cause the arms 270 to rotate in the second rotational direction 282 to lower the blades 274 relative to the frame 201 such that the blades 274 remain in contact with the field. Additionally or alternatively, the entire cutter bar assembly may translate along the vertical axis. That is, in addition to or as an alternative to rotating about the frame, the cutter bar assembly may slide along the frame in the vertical direction. Indeed, the cutter bar assembly 210 may be configured to move in any suitable manner relative to the frame 201 to enable the blades 274 to maintain contact with and/or to generally follow along contours of the field as the header 200 travels through the field. Further, the operator may provide inputs to set a cut height (of multiple available or possible cut heights), wherein the cut height defines a set point over a total range of motion of the cutter bar assembly 210 and is used to maintain the header 200 in consistent contact with the ground as the header 200 travels through the field. For each cut height (of the multiple available or possible cut heights), the cutter bar assembly 210 has a range of motion (e.g., via rotation about the second end 278; the range of motion is defined by a highest point of the first end 276 and a lowest point of the first end 276 relative to the frame 201).

The reel 220 may also move relative to the frame 201 and relative to the cutter bar assembly 210. In the illustrated embodiment, the frame 201 includes an extension 284 (e.g., a reel arm) that couples the reel member 221 (which includes the central framework 223 and the tines 222) to the frame 201. The extension 284 may position the reel member 221 above the cutter bar assembly 210 along the vertical axis 144 such that the reel 220 may urge the cut crops toward the blades 274. For instance, the reel member 221 may rotate in a third rotational direction 286 about a pivot point 288 that couples the reel member 221 to the extension 284. By rotating in the third rotational direction 286, the tines 222 may guide the crops toward the blades 274 that cut the crops.

The extension 284 may also rotate about a pivot point 285 that couples the extension 284 to the frame 201. Thus, the extension 284 may rotate about the frame 201 and may be configured to raise the reel 220 in a first rotational direction 287 (e.g., upward) relative to the vertical axis 144 and/or in a second rotational direction 289 relative to the vertical axis 144 (e.g., downward). In this way, the extension 284 may be positioned desirably relative to the cutter bar assembly 210 to enable the reel 220 to guide the crops to be cut by the cutter bar assembly 210. In an example, the reel 220 may be positioned proximate to the cutter bar assembly 210 without the tines 222 interfering (e.g., contacting) with the blades 274. The reel member 221 may also be configured to slide (e.g., fore/aft) relative to the extension 284. For example, the reel member 221 may slide in a rearward direction 291 and a forward direction 293 along the extension 284. Additionally or alternatively, the entire reel may translate along the vertical axis. That is, in addition to or as an alternative to rotating about the frame, the reel may slide along the frame in the vertical direction. Indeed, the reel may be configured to move in any suitable manner relative to the frame 201 to enable the tines 222 to capture and/or direct the crops as the header 200 travels through the field.

As shown, the header 200 includes and/or is communicatively coupled to a controller 290 (e.g., electronic controller; computing system) configured to perform calculations and/or control operating parameters of at least portions of the agricultural system, such as of the header 200. The controller 290 may include a memory 292 and a processor 294 (e.g., a microprocessor). The controller 290 may also include one or more storage devices and/or other suitable components. The processor 294 may be used to execute software, such as software for processing inputs, processing sensor feedback, assessing statistical movements of the cutter bar assembly 210 over time, modeling respective tine paths of tines 222 of the reel 220 at different positions of the reel 220, generating one or more boundaries, and/or controlling the agricultural system and/or the header 200.

Moreover, the processor 294 may include multiple microprocessors, one or more “general-purpose” microprocessors, one or more special-purpose microprocessors, and/or one or more application specific integrated circuits (ASICS), or some combination thereof. For example, the processor 294 may include one or more reduced instruction set (RISC) or complex instruction set (CISC) processors. The memory 292 may include a volatile memory, such as random access memory (RAM), and/or a nonvolatile memory, such as read-only memory (ROM). The memory 292 may store a variety of information and may be used for various purposes. For example, the memory 292 may store processor-executable instructions (e.g., firmware or software) for the processor 294 to execute, such as instructions for processing inputs, processing sensor feedback, assessing statistical movements of the cutter bar assembly 210 over time, modeling respective tine paths of tines 222 of the reel 220 at different positions of the reel 220, generating one or more boundaries, and/or controlling the agricultural system and/or the header 200. The memory 292 and/or the processor 294, or an additional memory and/or processor, may be located in any suitable portion of the agricultural system. By way of example, the controller 290 may be located in a cab of the agricultural system and/or on the header 200.

As shown, the header 200 may include one or more actuators 295 and one or more sensors 296. The one or more actuators 295 may be configured to move the extension 284 relative to the frame 201 to move the reel 220 up and down relative to the frame 201 and relative to the cutter bar assembly 210. The one or more actuators 295 may also be configured to move the reel member 221 fore and aft along the extension 284 to move the reel member 221 relative to the frame 201 and relative to the cutter bar assembly 210. In some embodiments, the one or more actuators 295 may be configured to define the range of motion of the cutter bar assembly 210 based on the cut height.

The sensors 296 may be disposed on the cutter bar assembly 210, on the reel 220, and/or any other suitable location of the header 200. Although two sensors 296 are shown to represent a presence of the sensors 296 on the cutter bar assembly 210 and/or on the reel 220, it should be appreciated that any number of sensors 296 may be placed at any of a variety of locations (e.g., proximate the first end 276 of the cutter bar assembly 210; proximate to a base of each tine 222). In any case, the sensors 296 may be configured to detect the respective positions of the cutter bar assembly 210 (e.g., a rotational position about the frame 201) and/or the respective positions of the reel 220 (e.g., a rotational position about the frame 201 and/or a longitudinal position relative to the frame 201). As used herein, the position of the reel 220 may refer to a position of the pivot point 288 relative to the frame 201.

The sensors 296 may also be configured to detect the relative positions of the cutter bar assembly 210 and the reel 220 (e.g., a distance between the cutter bar assembly 210 and the reel 220). In particular, the sensors 296 may be configured to detect when the reel 220 (e.g., the tines 222) are in an undesirable position relative to the cutter bar assembly 210 (e.g., within a threshold distance 297 of the cutter bar assembly 210, which may refer to being in proximity of the cutter bar assembly 210 and/or in contact with the cutter bar assembly 210). While the threshold distance 297 is illustrated between the cutter bar assembly 210 and the tines 222 of the reel 220 to facilitate discussion, it should be appreciated that the threshold distance 297 may be measured between any suitable portions of the cutter bar assembly 210 and the reel 220.

As described herein, the sensors 296 may detect each time the reel 220 is within the threshold distance 297 of the cutter bar assembly 210 in order to enable the controller 290 to verify that a boundary set for the reel 220 is providing expected results (e.g., operating with an appropriate risk level). In some embodiments, the sensor feedback from the sensors 296 may be used to generate and/or to update the boundary set for the reel 220. In some embodiments, each time the reel 220 is within the threshold distance 297 of the cutter bar assembly 210, the controller 290 may respond by controlling the one or more actuators 295 to move the reel 220 away from the cutter bar assembly 210 (e.g., to move the reel 220 in the first rotational direction 287). In some embodiments, the threshold distance 297 may essentially be zero, such that the sensors 296 detect when the reel 220 contacts the cutter bar assembly 210. In such cases, each time the reel 220 contacts the cutter bar assembly 210, the controller 290 may respond by controlling the one or more actuators 295 to move the reel 220 away from the cutter bar assembly 210 (e.g., to pivot to move the reel 220 in the first rotational direction 287). It should be appreciated that the sensors 296 may include position sensors, proximity sensors, electromagnetic sensors, reed switch sensors, hall effect sensors, optical sensors, contact sensors, or any suitable type of sensors.

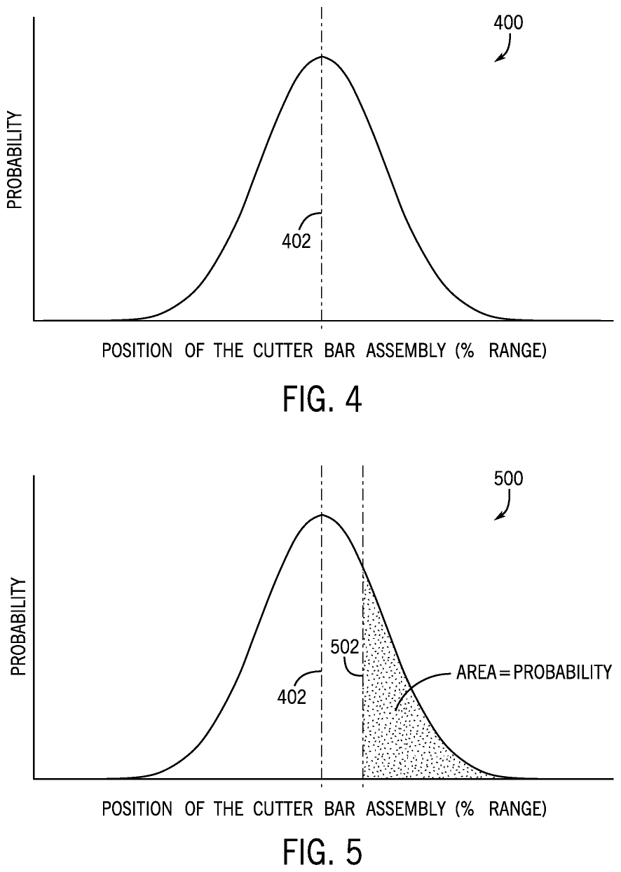

FIG. 4 is an example of a graph 400 that represents a distribution (e.g., a scaled distribution curve) of a position of a cutter bar assembly (e.g., the cutter bar assembly 210 of FIGS. 1-3) over a time period, in accordance with an embodiment of the present disclosure. In particular, a x-axis of the graph 400 represents positions of the cutter bar assembly across the range of motion of the cutter bar assembly over the time period (e.g., from 0 to 100 percent), and a y-axis of the graph 400 represents a probability that the cutter bar assembly will be in each of the positions of the cutter assembly across the range of motion of the cutter bar assembly.

As noted herein, the cutter bar assembly may flex and move relative to the frame of the header to maintain contact with the field during harvesting operations. Accordingly, the position of the cutter bar assembly may change over the time period, and the cutter bar assembly may be at certain positions more than other positions over the time period. The distribution of the position of the cutter bar assembly over the time period represents this, and the distribution can be scaled so that an area under a curve is equal to one (e.g., to generate a scaled distribution curve). Further, the distribution can be described as having a mean 402 and a standard deviation. The sensors, such as the sensors that detect the rotational position of the arms 270 of the cutter bar assembly 210 about the frame 201, may be utilized to detect the position of the cutter bar assembly over the time period and to generate the graph 400. In FIG. 4, the distribution is a Gaussian distribution to facilitate discussion; however, the distribution may have any of a variety of shapes.

FIG. 5 is an example of a graph 500 that represents a user-defined resultant position 502 of the cutter bar assembly (e.g., the cutter bar assembly 210 of FIGS. 1-3), in accordance with an embodiment of the present disclosure. For example, an input between 0 percent and 50 percent may be used to identify a point on the scaled distribution curve that is greater than the mean 402 and that represents or defines a corresponding portion of a total area under the scaled distribution curved. In some embodiments, the operator may provide the input between 0 percent and 50 percent that is used to identify the point on the scaled distribution curve. It should be appreciated that, in some embodiments, the operator may be prompted or allowed to provide a risk level input between 0 percent and 100 percent to facilitate understanding that the input is being used to set a risk level for contact between the reel and the cutter bar assembly. However, in such cases, the input would be scaled, such as by 50 percent, to result in the input between 0 percent and 50 percent that can be used to identify the point on the scaled distribution curve). As a more particular example with reference to FIG. 5, the operator may provide the input of 30 percent, which is then used to identify the point on the scaled distribution curve that represents or defines 30 percent of the total area under the scaled distribution curve. Further, this point on the scaled distribution curve is designated as the user-defined resultant position 502 and corresponds to some position of the cutter bar assembly that the cutter bar assembly was at less than or equal to 30 percent of the time period (and thus, is statistically expected to be at less than or equal to 30 percent of future periods of time as long as the cut height and field conditions remain generally stable). As described in more detail herein, the user-defined resultant position 502 enables the operator to choose a target risk level (e.g., in term of percent) for interference between the cutter bar assembly and the reel (e.g., the percent change of the cutter bar assembly and the reel being within the threshold distance/contacting one another).

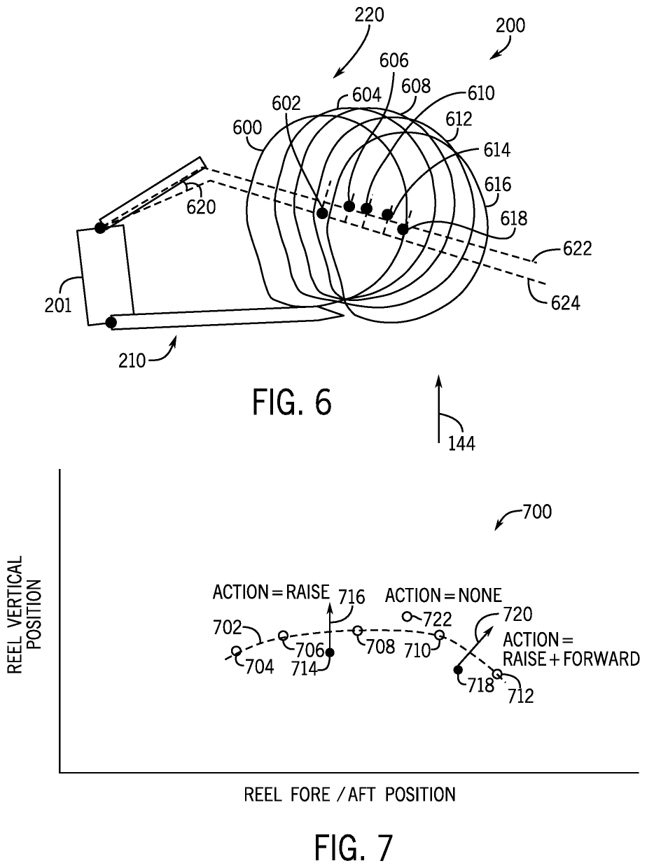

FIG. 6 is a schematic side view of a portion of the header 200 that represents a relationship between the user-defined resultant position (e.g., the user-defined resultant position 502 of FIG. 5) of the cutter bar assembly 210 and the reel 220, in accordance with an embodiment of the present disclosure. In FIG. 6, the cutter bar assembly 210 is represented in the user-defined resultant position. A first tine path 600 represents a respective path of tines of the reel 220 as the reel 220 rotates at a first reel position 602 (e.g., of the pivot point 288 shown in FIG. 3; fore/aft position relative to the frame 201 of the header 200). Similarly, a second tine path 604 represents a respective path of tines of the reel 220 as the reel 220 rotates at a second reel position 606 (e.g., of the pivot point 288 shown in FIG. 3; fore/aft position relative to the frame 201 of the header 200), a third tine path 608 represents a respective path of tines of the reel 220 as the reel 220 rotates at a third reel position 610 (e.g., of the pivot point 288 shown in FIG. 3; fore/aft position relative to the frame 201 of the header 200), a fourth tine path 612 represents a respective path of tines of the reel 220 as the reel 220 rotates at a fourth reel position 614 (e.g., of the pivot point 288 shown in FIG. 3; fore/aft position relative to the frame 201 of the header 200), a fifth tine path 616 represents a respective path of tines of the reel 220 as the reel 220 rotates at a fifth reel position 618 (e.g., of the pivot point 288 shown in FIG. 3; fore/aft position relative to the frame 201 of the header 200), and so on. Thus, the tine paths can be modeled at various fore/aft reel positions.

Further, at each of the various fore/aft reel positions, the reel 220 has a vertical range of motion as the reel arm may pivot about the frame 201 of the header 200. As shown, the vertical range of motion is provided as the reel arm may pivot through an angle 620, and the vertical range of motion is represented by lines 622 and 624. At each of the various fore/aft reel positions shown in FIG. 6, the reel 220 has a single limit position within the vertical range of motion at which the respective tine path intersects the cutter bar assembly 210 in the user-defined resultant position of the cutter bar assembly 210. Each single limit position may be used as a point that defines a boundary for the reel 220.

FIG. 7 is an example of a graph 700 of a boundary 702 for the reel (e.g., the reel 220 of FIGS. 1-3 and 6), in accordance with an embodiment of the present disclosure. FIG. 7 also indicates associated actions for the reel based on a position of the reel relative to the boundary for the reel. As noted herein, each single limit position identified as described with respect to FIG. 6 may be used as a point that defines the boundary 702 for the reel. For example, a first point 704 may correspond to the single limit position at the first reel position (e.g., determined based on the first tine path 600 as the reel 220 rotates at the first reel position 602, which defines the fore/aft position relative to the frame 201 of the header 200). Similarly, a second point 706 may correspond to the single limit position at the second reel position, a third point 708 may correspond to the single limit position at the third reel position, a fourth point 710 may correspond to the single limit position at the fourth reel position, a fifth point 712 may correspond to the single limit position at the fifth reel position, and so on. The boundary 702 may be created by connecting or otherwise fitting a line to the points, such as the points 702, 704, 706, 708, 710, 712. In this way, the boundary 702 for the reel may be determined via the modeling of the tine paths at the various fore/aft reel positions with respect to the user-defined resultant position of the cutter bar assembly 210.

Once the boundary 702 is established, the controller may provide one or more outputs based on the boundary 702. In some embodiments, the one or more outputs may include an action control signal to maintain and/or adjust (e.g., move) the reel at or above the boundary 702, a slow control signal to adjust (e.g., slow) movement of the reel below the boundary 702, a block control signal to block movement of the reel below the boundary 702, and/or an alert (e.g., visible and/or audible alert) to an operator in response to an operator input that instructs movement of the reel below the boundary 702. For example, in response to detecting that the reel is below the boundary 702 (and thus, that the reel is at a higher risk position than desired or set by the operator), the controller may instruct the actuator to adjust the reel relative to the frame of the header. In some embodiments, the controller may identify a vector that is perpendicular to the boundary 702 and that passes through a current position point that represents a current position of the reel (e.g., the current position of the pivot point 288 shown in FIG. 3). The controller may utilize the vector to determine whether to raise the reel, move the reel fore/aft, or a combination thereof (e.g., both raise the reel and move the reel fore/aft) to move across the boundary 702 (e.g., be above the boundary 702; to place the pivot point 288 shown in FIG. 3 above the boundary 702) via a shortest distance path.

For example, with reference to FIG. 7, the controller may receive sensor feedback that indicates that the reel is at a first current position point 714 below the boundary 702. In response, the controller may determine and/or analyze a first vector 716 that is perpendicular to the boundary 702 and that passes through the first current position point 714. As shown, the first vector 716 is vertical, and thus, the controller may instruct the actuator to raise the reel (e.g., without any fore/aft movement of the reel). Similarly, at some other time, the controller may receive sensor feedback that indicates that the reel is at a second current position point 718 below the boundary 702. In response, the controller may determine and/or analyze a second vector 720 that is perpendicular to the boundary 702 and that passes through the second current position point 718. As shown, the second vector 720 is vertical and forward, and thus, the controller may instruct the actuator to raise the reel and move the reel forward. Additionally, as shown, the controller may receive sensor feedback that indicates that the reel is at a third current position point 722 above the boundary 702. In response, the controller may not take any actions to move the reel, although the controller may provide information for visualization by the operator (e.g., via a display; to confirm that the current position is within the risk tolerance of the operator). Such techniques may be particularly effective and/or useful in cases in which the vertical movements and the horizontal movements of the reel are equal (e.g., substantially equal) in speed.

In some embodiments, the controller may consider variations in actuation/movement speed between the vertical movements and the horizontal movements of the reel. Because a goal is to move the reel across the boundary 702 as quickly as possible (e.g., in a shortest amount of time), the controller may apply respective weights to the vertical portions (e.g., vertical component) and the horizontal portions (e.g., horizontal component) of the vector, wherein the weights are proportional to the respective actuation/movement speeds of the vertical movements and the horizontal movements of the reel (e.g., a first weight to the vertical portion of the vector and a second weight to the horizontal portion of the vector, wherein a weight ratio between the first weight and the second weight is equal to a speed ratio between the vertical movement of the reel and the horizontal movement of the reel). In this way, the reel may move the reel across the boundary 702 as quickly as possible (but not necessarily over a shortest path possible). As a more specific example, if the vertical movement of the reel is 10 times faster than the horizontal movement of the reel, then the vertical potion of the vector should be weighted 10 times larger than the horizontal portion of the vector in order to utilize (e.g., maximize use of) the vertical movement of the reel (e.g., the faster adjustment direction).

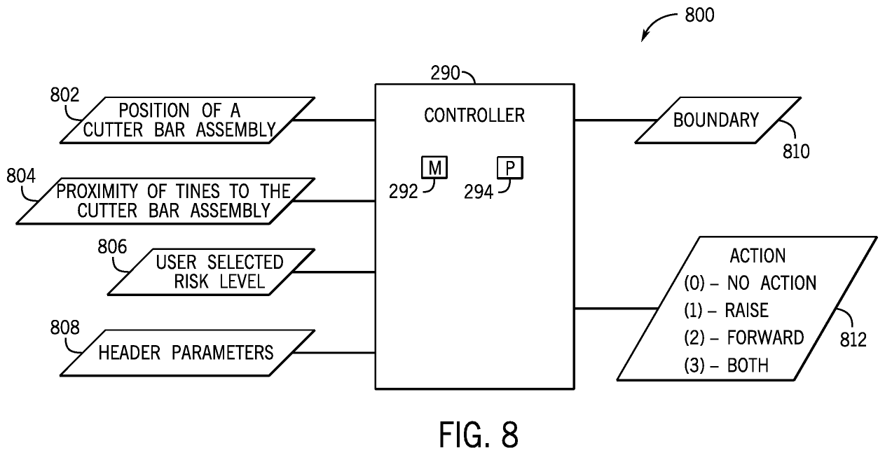

FIG. 8 is a schematic diagram of a control system 800 (e.g., electronic control system) that may be utilized to generate and to apply the boundary for the reel (e.g., the boundary 702 of FIG. 7 for the reel 220 of FIGS. 1-3 and 6), in accordance with an embodiment of the present disclosure. The control system 800 includes the controller 290 with the memory 292 and the processor 294. The controller 290 may receive various inputs, such as first inputs 802 indicative of the position of the cutter bar assembly over the time period, second inputs 804 indicative of a proximity of the tines of the reel to the cutter bar assembly, third inputs 806 indicative of a risk level, such as a user-selected risk level, and/or fourth inputs 808 indicative of other parameters of the header.

The first inputs 802 may be received from the sensor(s) that monitor the position of the cutter bar assembly relative to the frame of the header. The third inputs 806 may be received via inputs by the operator at a graphical user interface (e.g., on a display screen, such as in a cab of the agricultural system). However, it should be appreciated the third inputs 806 may not be inputs by the operator. For example, the controller 290, another device, and/or another system may access and/or determine the risk level based on any of a variety of factors, such as based on the other parameters of the header (e.g., the fourth inputs 808), the harvesting parameters during the current harvesting operations and/or prior harvesting operations, based on default settings, and the like. In such cases, the risk level and the related resultant position of the cutter bar assembly, as well as the boundary, may be set automatically by the controller 290 (e.g., not user-selected or user-defined; without the inputs by the operator). In any case, the controller 290 may process the first inputs 802 to determine the distribution of the position of the cutter bar assembly over the time period, and the distribution can be scaled so that an area under a scaled distribution curve is equal to one. Then, the controller 290 may utilize the third inputs 806 to set the user-defined resultant position of the cutter bar assembly. Then, the controller 290 may utilize the fourth inputs 808 to model the tine paths at different positions of the reel and compare the tine paths to the user-defined resultant position of the cutter bar assembly to identify points that correspond to limit points and to generate the boundary for the reel.

In some embodiments, the controller 290 may also receive the second inputs 804 and may use the second inputs 804 as feedback to verify occurrence of desired or expected behavior of the reel and the cutter bar assembly. For example, the controller 290 may use the second inputs 804 to count a number of instances or occurrences of the reel crossing the threshold distance (e.g., for particular fore/aft positions of the reel; hits). Further, the controller 290 may count an additional number of instances or occurrences of the reel being above the threshold distance (e.g., for particular fore/aft positions of the reel; misses). Then, the controller 290 may compare the number and the additional number (e.g., generate a ratio) to determine an actual risk percentage during operation of the header. Then, the controller 290 may compare the actual risk percentage to the user-selected risk level (that was used to set the boundary).

The controller 290 may update the boundary in response to a mismatch (e.g., lack of correspondence, by more than a threshold percentage, such as 5, 10, 15, or 20 percent) between the actual risk percentage and the user-selected risk level. In some embodiments, the controller 290 may update the boundary in response to the actual risk percentage exceeding the user-selected risk level by a first threshold percentage (e.g., such as 5 or 10 percent), and the controller 290 may update the boundary in response to the actual risk percentage being below the user-selected risk level by a second threshold percentage (e.g., such as 15 or 20 percent; greater than the first threshold percentage so as to provide relatively less tolerance for the actual risk percentage exceeding the user-selected risk level). In some embodiments, the controller 290 may update the boundary in response to the actual risk percentage exceeding the user-selected risk level (e.g., but not in response to the actual risk percentage matching or being below the user-selected risk level).

By adjusting the boundary in view of the second inputs 804, the controller 290 may enable efficient response to a change in field conditions (e.g., rougher ground will create a wider spread in the distribution), a cut height (e.g., this would shift the range of motion of the cutter bar assembly), and/or other events. The controller 290 may also adjust the boundary in response to updated or additional first inputs 802, third inputs 806, and/or fourth inputs 808. For example, the controller 290 may utilize a default boundary (e.g., stored at manufacturing; created during prior harvesting operations; multiple default boundaries that each correspond to a particular cut height) over an initial time period of a new, current harvesting operation. The controller 290 may collect the first inputs 802 over an initial time period (e.g., 1, 2, 3, 4, 5, or more minutes), and then utilize the first inputs 802 over the initial time period with the third inputs 806 and the fourth inputs 808 to generate the boundary (e.g., update the default boundary to generate the boundary that is appropriate for current field conditions and parameters of the header; for use during a current harvesting operation). Then, the controller 290 may adjust the boundary continuously or periodically as the header travels through the field, in response to a change in the user-selected risk level, in response to a change in the cut height or other parameters of the header, in response to the sensor feedback, and so forth. It should be appreciated that, in some embodiments, the second inputs 804 may be omitted (e.g., not received and/or not considered by the controller 290 to determine the boundary and/or to determine the one or more actions). Indeed, the header may be devoid of any sensors that measure proximity of the tines to the cutter bar assembly.

The controller 290 may provide the boundary (e.g., the current risk level) as a first output 810, as well as instruct an action as a second output 812. As discussed herein, the action may include maintaining the reel at or above the boundary (e.g., no action) and/or adjusting (e.g., moving) the reel at or above the boundary (e.g., raise, forward, or both). In some embodiments, the controller may block the reel from being moved across (e.g., below; toward the cutting bar assembly) the boundary. Additionally or alternatively, the controller may slow movement of the reel below the boundary (e.g., move the reel at a first, faster rate above the boundary and move the reel at a second, slower rate below the boundary; move the reel quickly to a set point above the boundary, move the reel slowly via small incremental steps toward the set point below the boundary until detection of a threshold distance), provide an alert to the operator in response to the operator input that instructs movement of the reel below the boundary, and/or provide other outputs based on the boundary. In some embodiments, the second output 812 may vary based on the risk level of the boundary (e.g., block the reel from being positioned below the boundary with the high risk level, but provide the alert, while also permitting movement of the reel below the boundary with the low risk level).

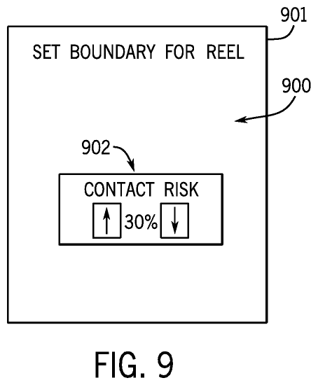

FIG. 9 is a graphical user interface (GUI) 900 that may be provided via a display screen 901, in accordance with an embodiment of the present disclosure. The display screen 901 may be located in a cab of the agricultural system or at any suitable location (e.g., remote from the agricultural system). As noted above, the boundary may be established for the header, and the boundary is based on a risk level (e.g., user-selected risk level) for contact between the reel and the cutter bar assembly. For example, to facilitate entry of the user-selected risk level, the controller may instruct the GUI 900 to present selectable icons 902 (e.g., virtual buttons). For example, the selectable icons 902 may include a selectable up arrow that raises the user-selected risk level and a selectable down arrow that lowers the user-selected risk level (e.g., relative to a current risk level shown on the GUI 900, such as 30 percent in FIG. 9). It should be appreciated that other configurations are envisioned, such as selectable icons 902 for different risk levels (e.g., one for 10 percent, 20 percent, 30 percent, 40, percent, 50 percent). In any case, the operator may interact with the GUI 900 to set the user-selected risk level based on a preference related to the risk level for contact between the reel and the cutter bar assembly. It should be appreciated that the user-selected risk level (and thus, the risk level associated with the boundary) may represent the chance of contact and/or the chance of the reel being within the threshold distance of the cutter bar assembly (e.g., 40 percent chance of contact or 40 percent chance of the reel being within the threshold distance of the cutter bar assembly).

Advantageously, the techniques disclosed herein provide an adaptive boundary that is specific to the header, wherein the adaptive boundary updates over time (e.g., over the initial period of a current harvesting operation; periodically or throughout the harvesting operation). The techniques disclosed herein also convey the different boundary options to the operator in a manner that enables the operator to understand possible consequences of their selection, such as that selection of a higher percentage (e.g., 50 percent) has a high likelihood (e.g., 50 percent chance) of resulting in contact between the reel and the cutter bar assembly as the header travels through the field during harvesting operations, while selection of a lower percentage (e.g., 10 percent) has a low likelihood (e.g., 10 percent chance) of resulting in contact between the reel and the cutter bar assembly as the header travels through the field during harvesting operations Certain operators may still choose to select the higher percentage (e.g., the higher risk of contact) in certain situations, such as when the crop is a high-value crop that is difficult to harvest without this close positioning of the reel and the cutter bar assembly.

In some embodiments, the controller may instruct output of an indication on the display screen 901 to alert the operator in response to receipt of an input (e.g., from the operator) that commands the reel to move below the boundary. The controller may enable the operator to confirm the input and, in response to the confirmation, the controller may then instruct the reel to move below the boundary. In this way, the operator may be alerted and provide instructions to override the boundary. It should be appreciated that any of a variety of other information may be provided on the display screen, such as the data points, any of the graphs provided herein, selectable icons to designate to block the downward movement of the reel below the boundary, limit the downward movement of the reel below the boundary, provide alerts, require confirmation prior to the downward movement below the boundary, or the like.

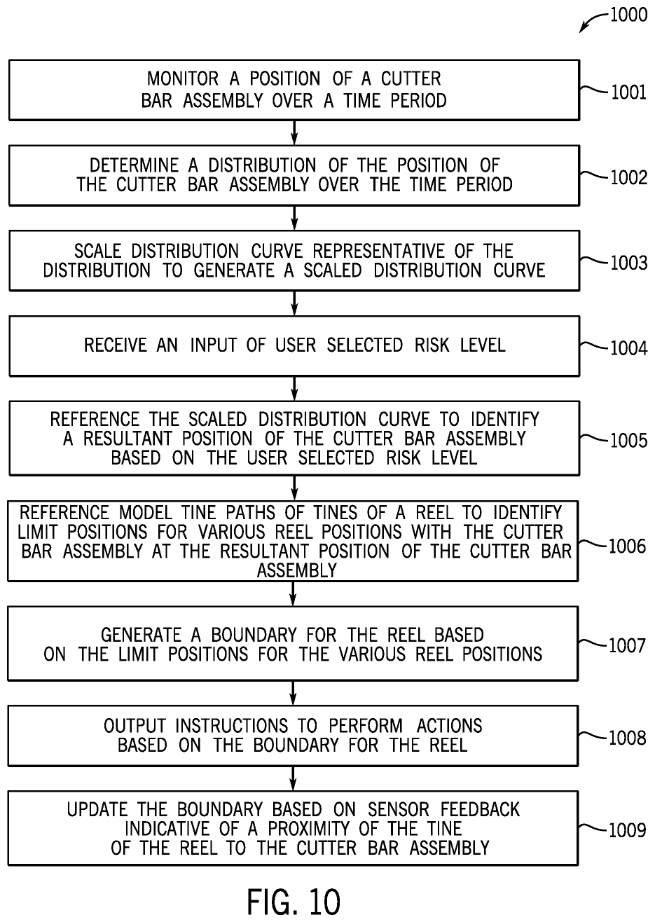

FIG. 10 is a flowchart of a method 1000 for generating a boundary for a reel of a header, in accordance with an aspect of the present disclosure. The flowchart includes various steps represented by blocks. Although the flowchart illustrates the steps in a certain sequence, it should be understood that the steps may be performed in any suitable order and certain steps may be carried out simultaneously, where appropriate. Further, certain steps may be omitted and/or other steps may be added. While certain steps are described as being performed by a controller, it should be understood that the steps or portions thereof may be performed by any suitable processing device.

In block 1001, the controller may monitor a position of a cutter bar assembly over a time period. For example, the controller may receive signals from sensors that detect the position of an arm of the cutter bar assembly relative to a frame of a header during an initial portion of a current harvesting operation. In block 1002, the controller may determine a distribution of the position of the cutter bar assembly over the time period. In block 1003, the controller may scale a distribution curve representative of the distribution to generate a scaled distribution curve.

In block 1004, the controller may receive an input of a risk level (e.g., a user-selected risk level). For example, an operator may provide the input via interaction with a graphical user interface based on their tolerance or desired risk level for contact between the cutter bar assembly and a reel during the current harvesting operation. The controller, another device, and/or another system may access and/or determine the risk level based on any of a variety of factors, such as based on harvesting parameters during the current harvesting operations and/or prior harvesting operations, based on default settings, and the like. In block 1005, the controller may reference the scaled distribution curve to identify a resultant position of the cutter bar based on the user-selected risk level. For example, the controller may use the user-selected risk level to identify a point on the scaled distribution curve that represents or defines a corresponding portion of a total area under the scaled distribution curve.

In block 1006, the controller may generate and/or reference model tine paths of tines of the reel to identify limit positions for various reel positions (e.g., one vertical limit position for each fore/aft position of the reel) with the cutter bar at the resultant position of the cutter bar assembly. In block 1007, the controller may generate a boundary for the reel based on the limit positions for the various reel positions. In block 1008, the controller may monitor the position of the reel (or a commanded position of the reel), and then output instructions to perform actions based on the position of the reel relative to the boundary for the reel. For example, the action may include maintaining the reel at or above the boundary (e.g., no action) and/or adjusting (e.g., moving) the reel at or above the boundary (e.g., raise, forward, or both; based on a vector or a weighted portions of the vector).

In block 1009, the controller may update the boundary based on sensor feedback (e.g., from sensors) indicative of a proximity of the tines of the reel to the cutter bar assembly. For example, the controller may update the boundary in response to a mismatch (e.g., lack of correspondence, by more than a threshold percentage, such as 5, 10, 15, or 20 percent) between an actual risk percentage indicated by the sensor feedback and the user-selected risk level over some period of time of the current harvesting operations.

While only certain features have been illustrated and described herein, many modifications and changes will occur to those skilled in the art. It is, therefore, to be understood that the appended claims are intended to cover all such modifications and changes as fall within the true spirit of the disclosure. It should be appreciated that any features described with reference to FIGS. 1-10 may be combined in any suitable manner.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

1. An agricultural system, comprising:
a frame;
a cutter bar assembly configured to cut crops and to move relative to the frame during a harvesting operation of the agricultural system;
a reel configured to guide the crops toward the cutter bar assembly and to move relative to the frame during the harvesting operation of the agricultural system; and
a controller configured to:
receive data indicative a position of the cutter bar assembly relative to the frame over a first time period of the harvesting operation;
receive an input of a risk level for contact between the cutter bar assembly and the reel during the harvesting operation;
generate a boundary for the reel based on the position of the cutter bar assembly relative to the frame over the first time period of the harvesting operation and the input; and
control the reel based on the boundary during a second time period of the harvesting operation.

2. The agricultural system of claim 1, wherein the controller is configured to:
access models of tine paths of tines of the reel;
use the models to identify a plurality of vertical limit positions for the reel, wherein each vertical limit position of the plurality of vertical limit positions corresponds to a respective fore/aft position of the reel relative to the frame of the agricultural system; and
generate the boundary for the reel based on the position of the cutter bar assembly relative to the frame over the time period of the harvesting operation, the input, and the plurality of vertical limit positions for the reel.

3. The agricultural system of claim 1, wherein the controller is configured to:
generate a distribution curve based on the data indicative of the position of the cutter bar assembly relative to the frame over the first time period of the harvesting operation; and
scale the distribution curve to generate a scaled distribution curve, wherein an area under the scaled distribution curve is equal to one, and the scaled distribution curve represents a respective probability for each possible position of the cutter bar assembly across a range of motion of the cutter bar assembly relative to the frame.

4. The agricultural system of claim 3, wherein the controller is configured to identify a resultant position of the cutter bar assembly based on the input and the scaled distribution curve.

5. The agricultural system of claim 4, wherein the controller is configured to identify the resultant position of the cutter bar assembly at a point on the scaled distribution curve that causes the risk level to correspond to a total area under the scaled distribution curve.

6. The agricultural system of claim 1, wherein the controller is configured to receive additional sensor data indicative of occurrences of the reel being in an undesirable position relative to the cutter bar assembly during the second time period.

7. The agricultural system of claim 6, wherein the controller is configured to update the boundary based on the additional sensor data.

8. The agricultural system of claim 6, wherein the controller is configured to:
calculate an actual risk of contact between the cutter bar assembly and the reel during the harvesting operation based on the additional sensor data;
compare the actual risk of contact to the risk level; and
update the boundary in response to a mismatch between the actual risk of contact and the risk level.

9. The agricultural system of claim 1, wherein the controller is configured to control the reel based on a default boundary during the first time period of the harvesting operation.

10. The agricultural system of claim 1, wherein the risk level comprises a user-selected risk level set by an operator of the agricultural system.

11. The agricultural system of claim 10, wherein the controller is configured to instruct output of a graphical user interface on a display screen, and the graphical user interface facilitates the input of the user-selected risk level as a percentage risk level.

12. The agricultural system of claim 1, wherein the controller is configured to control the reel by blocking the reel from moving across the boundary toward the cutter bar assembly during the second time period of the harvesting operation.

13. The agricultural system of claim 1, wherein the controller is configured to control the reel by adjusting the reel from a first position below the boundary with respect to the cutter bar assembly to a second position above the boundary with respect to the cutter bar assembly.

14. The agricultural system of claim 13, wherein the control is configured to:
calculate a vector that is perpendicular to the boundary and that passes through a current position point that represents a current position of the reel; and
determine to raise the reel, move the reel fore/aft, or a combination thereof to move the reel across the boundary based on components of the vector.

15. An agricultural system, comprising:
a controller configured to:
receive data indicative a position of a cutter bar assembly of a header of the agricultural system relative to a frame of the header over a first time period of a harvesting operation;
receive an input of a risk level for contact between the cutter bar assembly and a reel of the header during the harvesting operation;
generate a boundary for the reel based on the position of the cutter bar assembly relative to the frame over the first time period of the harvesting operation and the input; and
control the reel based on the boundary during a second time period of the harvesting operation.

16. The agricultural system of claim 15, wherein the controller is configured to:
access models of tine paths of tines of the reel;
use the models to identify a plurality of vertical limit positions for the reel, wherein each vertical limit position of the plurality of vertical limit positions corresponds to a respective fore/aft position of the reel relative to the frame of the header; and
generate the boundary for the reel based on the position of the cutter bar assembly relative to the frame over the first time period of the harvesting operation, the input, and the plurality of vertical limit positions for the reel.

17. The agricultural system of claim 15, wherein the controller is configured to:
generate a distribution curve based on the data indicative the position of the cutter bar assembly relative to the frame over the first time period of the harvesting operation, wherein the distribution curve represents a respective probability for each possible position of the cutter bar assembly across a range of motion of the cutter bar assembly relative to the frame; and
identify a resultant position of the cutter bar at a point on the distribution curve that causes the risk level to correspond to a total area under the distribution curve.

18. A method of operating an agricultural system, comprising:
receiving, at one or more processors, data indicative a position of a cutter bar assembly relative to a frame over a first time period of a harvesting operation;
receiving, at the one or more processors, an input of a risk level for contact between the cutter bar assembly and a reel during the harvesting operation;
generating, using the one or more processors, a boundary for the reel based on the position of the cutter bar assembly relative to the frame over the first time period of the harvesting operation and the input; and
controlling, using the one or more processors, the reel based on the boundary during a second time period of the harvesting operation.

19. The method of claim 18, comprising:
accessing, using the one or more processors, models of tine paths of tines of the reel;
analyzing, using the one or more processors, the models to identify a plurality of vertical limit positions for the reel, wherein each vertical limit position of the plurality of vertical limit positions corresponds to a respective fore/aft position of the reel relative to the frame; and
generating, using the one or more processors, the boundary for the reel based on the position of the cutter bar assembly relative to the frame over the first time period of the harvesting operation, the input, and the plurality of vertical limit positions for the reel.

20. The method of claim 18, comprising blocking, using the controller, the reel from moving across the boundary toward the cutter bar assembly during the harvesting operation.
